(19) United States
(12) Patent Application Publication
(10) Pub. No.: US 2026/0033915 A1
(43) Pub. Date: Feb. 5, 2026

(54) METHOD FOR MANUFACTURING AN ORTHODONTIC SPLINT

(71) Applicant: Patrice BERGEYRON, CORSIER (FR)

(72) Inventor: Patrice BERGEYRON, CORSIER (CH)

(21) Appl. No.: 19/101,337

(22) PCT Filed: Aug. 9, 2023
(86) PCT No.: PCT/EP2023/072012

§ 371 Date: Feb. 5, 2025

(30) Foreign Application Priority Data
Aug. 9, 2022 (FR) FR2208201

(51) Int. Cl. A61C 7/00; A61C 7/08

(52) U.S. Cl. CPC A61C 7/002; A61C 7/08

(57) ABSTRACT

A method for manufacturing at least one orthodontic splint includes generating a digital three-dimensional model of the support arch, and on the basis of the digital three-dimensional model of the support arch, generating a digital three-dimensional model of the orthodontic splint designed such that the orthodontic splint can be removably attached to the support arch. The orthodontic splint defines, in its use position, with the support arch, a cavity (16) designed to accommodate an auxiliary device (20). The orthodontic splint is manufactured on the basis of the model of the orthodontic splint.

### TECHNICAL FIELD

The present invention relates to a method for manufacturing an orthodontic aligner, an appliance comprising such an orthodontic aligner, and a complementary orthodontic device.

### PRIOR ART

To correct a malocclusion or to modify a user's appearance in particular, it is desirable to modify the position of one or more teeth of a user.

Among the orthodontic devices used for this purpose, a distinction is made in particular between, on the one hand, orthodontic devices with an archwire and brackets and, on the other hand, orthodontic aligners.

In an orthodontic device with an archwire and brackets, the brackets are fixed to the teeth and connected to one another by means of an archwire, conventionally made from a shape-memory material. It has a rapid action in moving the teeth of the patient who is being treated. However, this action slows progressively over time, and the patient has to visit the orthodontist regularly in order to modify the setting of the archwire or to change the latter. Furthermore, an orthodontic device with an archwire and brackets is often visually unattractive. Finally, it defines recesses within which food is able to accumulate, even when the user regularly brushes their teeth.

An orthodontic aligner conventionally takes the form of a removable, one-piece device, conventionally made of a transparent polymer material. It comprises a tray, with the overall shape of a “U”, which is configured to receive multiple teeth of a dental arch, generally all the teeth of a dental arch. The shape of the tray is adapted so that, in the position of use, it holds the orthodontic aligner in position on the teeth, while exerting a stress on the teeth, for example in order to modify the arrangement thereof. Conventionally, a series of orthodontic aligners is manufactured and supplied to the user, who wears the aligners successively. Advantageously, the users themselves are able to replace the orthodontic aligner. Furthermore, the aligners are more discreet than devices with an archwire and brackets. They can be easily cleaned or replaced. However, the action of an orthodontic aligner is slow, with the result that the orthodontic treatment may last several months. Finally, certain movements of the teeth cannot be obtained exclusively with orthodontic aligners, since the orthodontic aligners can slide over the teeth (“soap effect”).

There is an ongoing need for a method for manufacture of an orthodontic aligner that at least partly meets the problems set out above.

An object of the invention is to respond, at least in part, to this need.

### DISCLOSURE OF THE INVENTION

### Summary of the Invention

The invention provides a method for manufacturing at least one orthodontic aligner, also referred to hereinafter as “new orthodontic aligner”, intended to be carried, in a position of use, by a user's dental arch, referred to as a “supporting arch”, said orthodontic aligner being configured such that, in said position of use, it defines with the supporting arch a cavity, preferably a cavity having a volume of greater than 5 mm³, preferably greater than 80 mm³.

The method preferably comprises the following steps:
a) generating a digital three-dimensional model of the supporting arch;
b) from the model of the supporting arch, generating a digital three-dimensional model of the orthodontic aligner configured in such a way that said orthodontic aligner can be fixed, in a removable manner, to the supporting arch, in a position of use, and such that said orthodontic aligner, in said position of use, defines, with the supporting arch, a cavity having a volume of preferably greater than 5 mm³, preferably greater than 80 mm³;
c) manufacturing said orthodontic aligner from the model of the orthodontic aligner.

According to the invention, the cavity comprises an occlusal free space extending between the occlusal inner surface of the orthodontic aligner and the occlusal surface of the supporting arch, the occlusal free space
extending over a length L greater than the length of more than one tooth of the supporting arch, said lengths being measured along the longitudinal axis X of the orthodontic aligner, and having a height greater than 1 mm, and/or
being configured to accommodate an auxiliary device preferably having a member connecting a first surface of a first tooth to a second surface of a second tooth, said first and second surfaces belonging to the surface of the supporting arch defining the cavity, only one of the first and second teeth preferably being entirely accommodated in the cavity, the method comprising, before step b), determining the auxiliary device.

A tooth of the supporting arch that is entirely accommodated in the cavity, or that is likely to erupt into the cavity so as to be entirely accommodated therein, is referred to as a “free tooth”.

The region of said orthodontic aligner defining said cavity is referred to as a “cavity region”. To evaluate whether the length of the occlusal free space is greater than “the length of more than one tooth of the supporting arch”, the teeth of the supporting arch that extend opposite said occlusal free space are of course taken into consideration. The cavity region therefore covers more than one tooth, and in particular two or three or four free teeth. It can also cover one, two, three or four free teeth and only part of another tooth, referred to as an “enveloped tooth”.

Said height can be in particular
a local height, measured at a point on the occlusal surface of the supporting arch that defines the cavity,
a mean height, an arithmetic mean, on the occlusal surface of the supporting arch that defines the cavity,
a maximum height, considering all the points on the occlusal surface of the supporting arch that defines the cavity,
a minimum height, considering all the points on the occlusal surface of the supporting arch that defines the cavity.

As will be seen in greater detail in the remainder of the description, the cavity can be configured to allow and protect a natural development of a free tooth, and in particular its eruption, over a long period of time.

The cavity can thus be configured to provide a “leeway” space, so that at least one free tooth can suitably erupt therein. The orthodontic aligner is then configured to have sufficient rigidity to prevent the teeth adjacent to the cavity from blocking it. The orthodontic aligner is preferably configured in such a way as to guide the eruption of at least one free tooth.

The cavity can be configured to form a technical space, alternatively or in addition to a leeway space. The cavity is preferably designed to receive at least part, preferably all, of an orthodontic device rigidly fixed, in a non-removable manner, to at least one free tooth, or “auxiliary device”, the auxiliary device being chosen at the start of the method.

The auxiliary device preferably comprises at least one hook.

The auxiliary device can be used in particular to rotate a tooth.

The auxiliary device can advantageously be designed to exert a much stronger local action than is the case with a conventional orthodontic aligner. It thus allows effective correction of the position of a tooth. This action can advantageously be complex and can in particular include a rotation of a tooth on itself.

The auxiliary device preferably comprises a first hook rigidly fixed to the first tooth, a second hook rigidly fixed to said free tooth, and the member physically connecting the first hook to the second hook, preferably in order to exert a tension between said first and second hooks, preferably to rotate the free tooth by more than 20°.

The auxiliary device can be a wire adhesively bonded to the first and second surfaces.

The member is preferably tensioned in order to exert a force for bringing the first and second teeth together.

Preferably, the technical space is dimensioned so that said auxiliary device can function without being in contact with the orthodontic aligner or without such contact substantially interacting with said function.

Preferably, the orthodontic aligner is not in contact with the auxiliary device or the part of the auxiliary device accommodated in the cavity.

In one embodiment, the cavity constitutes a rotation space for at least one free tooth capable of rotating there by more than 10°, preferably by more than 20°, preferably by more than 30° in the position of use, preferably a space dimensioned so that said free tooth can perform said rotation without being in contact with the orthodontic aligner or without such contact substantially interacting with said rotation.

The orthodontic aligner protects the free teeth and/or the auxiliary device placed in the cavity, in particular from impacts. It can isolate them from the environment.

In one embodiment, the orthodontic aligner is configured to hold the teeth in position or move them toward a target position, like conventional orthodontic aligners. In one embodiment, none of said teeth erupts in the cavity.

In one embodiment, the method comprises, after the manufacture of the orthodontic aligner, supplying said orthodontic aligner to a user, and optionally positioning the orthodontic aligner in the position of use.

In one embodiment, in step a), a model of an auxiliary device is also generated and, in step b), the model of the auxiliary device is positioned on the model of the supporting arch, and the model of the orthodontic aligner is generated such that, in the position of use, the auxiliary device is partly or preferably completely in the cavity defined by the orthodontic aligner.

The model of the auxiliary device is positioned on the model of the supporting arch in the same way as the auxiliary device is to be positioned on the supporting arch in the position of use.

The model of the supporting arch on which the model of the auxiliary device has been positioned represents the surface on which the orthodontic aligner is to be positioned in the position of use. This surface can be locally deformed in order to define the cavity. It can also be used to define the rest of the inner surface of the orthodontic aligner, notably with a view to attaching it to the teeth.

In one embodiment, the invention relates to a method for manufacturing at least one orthodontic aligner intended to be carried, in a position of use, by a user's dental arch, referred to as a “supporting arch”, the supporting arch
comprising a first tooth and a second tooth and
carrying or being intended to carry an auxiliary device comprising a member connecting a first surface of the first tooth to a second surface of the second tooth, the method comprising the following steps:
a) generating a digital three-dimensional model of the supporting arch;
b) from the digital three-dimensional model of the supporting arch, generating a digital three-dimensional model of the orthodontic aligner configured in such a way that
said orthodontic aligner can be fixed, in a removable manner, to the supporting arch, in a position of use,
said orthodontic aligner, in the position of use, defines, with the supporting arch, a cavity configured to accommodate the auxiliary device, said first and second surfaces belonging to the surface of the supporting arch defining, with said orthodontic aligner, said cavity, only the first tooth, from the first and second teeth, being accommodated entirely in the cavity, and
c) manufacturing said orthodontic aligner from the model of the orthodontic aligner; the region of said orthodontic aligner defining said cavity being referred to as a “cavity region”.

In step b), the digital three-dimensional model of the supporting arch can conventionally be used to define the inner surface of the orthodontic aligner, in particular to allow the orthodontic aligner to be attached to the teeth of the dental arch. It can also be deformed locally, by means of a computer, in order to create the cavity.

In general, the production of orthodontic aligners from models of supporting arches is well known to those skilled in the art.

The surface of the second tooth partially delimits the cavity, in particular for attachment of the member. However, the surface of the second tooth extends partially out of the cavity, so as to be in contact with the orthodontic aligner, and thus to be held in position by the orthodontic aligner.

Preferably, the second tooth (which is not accommodated entirely in the cavity) is held in position by the orthodontic aligner so as to serve as an anchor. The traction or compression action of the member thus results substantially exclusively in a movement of the first tooth (which is accommodated entirely in the cavity and can therefore move freely).

Preferably, the orthodontic aligner is configured to hold not only the second tooth in position but also one other tooth or preferably several other teeth of the supporting arch, preferably more than 2, more than 5, more than 10 other teeth. These other teeth also advantageously contribute to holding the second tooth in position, that is to say to anchoring it.

Preferably, the orthodontic aligner is configured so as to be in contact with more than 10%, more than 20%, more than 30%, more than 40%, preferably more than 50% of the surface area of the second tooth (which is not accommodated entirely in the cavity), thereby improving the anchoring action.

Preferably, the orthodontic aligner is configured so as to be in contact with less than 90%, or less than 80% of the surface area of the second tooth.

Preferably, the orthodontic aligner, in the region intended to be in contact with the second tooth, has a shape complementary to the surface of the second tooth. In the position of use, the orthodontic aligner preferably does not exert any action tending to move the second tooth. This action is preferably limited to an action of maintaining position in order to counter the action of the member of the auxiliary device, such that this action results mainly in a movement of the first tooth, which is accommodated entirely in the cavity.

In other words, the second tooth is held in position (that is to say held immobile on the arch) by the orthodontic aligner so as to serve as an anchor. The traction or compression action of the member thus results substantially exclusively in a movement of the first tooth.

In one embodiment, the cavity constitutes a rotation space for the first tooth capable of rotating there by more than 10°, preferably by more than 20°, preferably by more than 30° in the position of use, preferably a space dimensioned so that said first free tooth can perform said rotation without being in contact with the orthodontic aligner or without such contact substantially interacting with said rotation.

In one embodiment, the digital three-dimensional model of the orthodontic aligner is configured such that, in the position of use, the orthodontic aligner modifies the position and/or the orientation of at least a third tooth other than the first and second teeth, preferably in order to correct a malocclusion. Thus, the orthodontic aligner can not only serve to improve the anchoring of the second tooth, but also serve to correct a malocclusion.

In one embodiment, a manufacturing method according to the invention is repeated so as to manufacture, and preferably supply to the user, a set of new orthodontic aligners intended to be worn successively by the user, in particular in order to correct a malocclusion or to facilitate the eruption of a tooth, preferably without interacting with the action of a said auxiliary device, except for improving the anchoring of the second tooth.

The invention also relates to a computer medium or a computer, in which a model of a supporting arch and a model of a new orthodontic aligner suitable for the supporting arch are recorded. In other words, in a position of use, an orthodontic aligner having the shape of said model of the orthodontic aligner defines, with said supporting arch, a cavity having a volume of greater than 5 mm³.

In a preferred embodiment, a method according to the invention also has one or more of the following optional features:
the orthodontic aligner is configured in such a way that, in the position of use and in an occlusion position, the outer occlusal surface of the cavity region
is not in contact with the teeth of the dental arch antagonist to the supporting arch, or
is in contact with the teeth of the dental arch antagonist to the supporting arch and is deformable under the effect of masticatory forces;
the orthodontic aligner has, in said cavity region, a plane occlusal outer surface and/or a plane occlusal inner surface or has
a shape identical or similar to at least one free tooth capable of erupting in the cavity, in a predefined position of said free tooth, the predefined position preferably being the desired position of the free tooth at the end of said eruption,
preferably, a shape such that, in said predefined position, no point of said free tooth is spaced apart by more than 1 mm, preferably 0.5 mm, from said one occlusal inner surface;
the thickness of material between the occlusal outer and inner surfaces of the cavity region is preferably substantially constant;
the cavity is preferably closed;
the cavity region has a plane occlusal outer surface;
in the position of use, more than 50% of the surface area of the lingual faces and/or of the vestibular faces of the free tooth or teeth is in contact with the intrados inner surface and/or the extrados inner surface, respectively, of the orthodontic aligner, preferably without exerting a movement stress on said teeth, preferably by exerting only fastening stresses;
the cavity is dimensioned to allow an erupted free tooth, that is to say a tooth that is not embedded under the surface of the gum, to rotate on itself about an axis passing through its center and perpendicular to its occlusal face, over an angular sector greater than 20°;
the cavity has a length, measured along the longitudinal axis of the orthodontic aligner, of greater than 10 mm;
the cavity has an occlusal free space extending between the bottom of the orthodontic aligner and the occlusal face of the free tooth or teeth that are accommodated in the cavity, or between said bottom and the gum in the absence of a free tooth in the cavity, said occlusal free space preferably representing more than 80% of the volume of the cavity.

Preferably, the method according to the invention is implemented in order to manufacture a set of new orthodontic aligners intended to be worn successively in the context of an orthodontic treatment, preferably a conventional orthodontic treatment, preferably an orthodontic treatment intended to correct a malocclusion. The orthodontic aligners can thus be conventional orthodontic aligners simply adapted to create one or more cavity regions.

The invention also relates to:
a computer program, comprising program code instructions for designing a new orthodontic aligner or a set of new orthodontic aligners, autonomously or in cooperation with an operator, for example an orthodontist, preferably for generating 3D models of said orthodontic aligner(s), and/or for controlling a machine for manufacturing said orthodontic aligner(s);
a computer medium on which such a program is recorded, for example a memory or a CD-ROM, and
a computer in which such a program is loaded.

The invention also relates to
a new orthodontic aligner;
a said set of new orthodontic aligners;
an appliance comprising a new orthodontic aligner and a said auxiliary device intended to be fixed, in a non-removable manner, to a free tooth of the supporting arch such that, in the position of use, said auxiliary device is partially or preferably entirely accommodated in the cavity;
a system comprising a computer according to the invention and a said machine, for manufacturing said orthodontic aligners, controlled by said computer.

### Definitions

A “user” is understood to mean any person for whom a method according to the invention is implemented, whether this person is ill or not.

The term “tooth” is used to denote the dental crown, that is to say the part of the tooth emerging from the gum.

A “clenching of the teeth” is an action by which the user presses the lower jaw against the upper jaw.

The “position of use” is the position of an orthodontic aligner when it has been fastened to a dental arch. Conventionally, the fastening can be deactivated by the user, by simply pulling on the aligner.

The “vertical” and “horizontal” directions relate to the position of use, the user holding their head upright.

The “supporting arch” is the mandibular or maxillary dental arch that carries the new orthodontic aligner in the position of use.

The “occlusion position” is a position in which the user clenches the teeth while the orthodontic aligner is in the position of use.

A member attached to the supporting arch is said to be “removable” when it can be detached by hand by the user. An orthodontic aligner is removable. A hook adhesively bonded to a tooth is not removable.

A “hook” generally denotes a member fixed in a non-removable manner to a tooth, conventionally adhesively bonded to a tooth, and designed to rigidly hold another orthodontic member, such as a metal archwire or an elastic band.

The term “tray” or “inner surface” denotes the surface of the orthodontic aligner defining the recess that receives the teeth in the position of use. As is illustrated in FIG. 1, an orthodontic aligner 10 defines a tray 13 composed of:
an occlusal inner surface 13o oriented toward the occlusal plane Po when the user closes their mouth, FIG. 3 representing this surface with a thick dashed line,
an intrados inner surface 13i, which faces the lingual faces of the teeth received in the tray, and
an extrados inner surface 13e, which faces the vestibular faces of the teeth received in the tray.

The “occlusal surface” of the supporting arch, labeled “11” and represented by a thick and continuous line in FIG. 3, is the surface of the supporting arch that faces the occlusal inner surface 130 of the orthodontic aligner in the position of use. This surface is notably defined by the occlusal faces of the teeth and by the occlusal surface of the gum, which surface possibly extends between the teeth, in particular which surface extends above the occlusal faces of embedded teeth.

The distance between a first point of the occlusal surface of the supporting arch and the closest point of the occlusal inner surface 130 of the orthodontic aligner defines the height “h” of the occlusal free space at this first point.

In an orthonormal frame of reference (Oxyz) that is fixed with respect to a tooth, the tooth can carry out, at one time, up to six elementary transformations, namely a translation along the axis Ox), and/or a translation along the axis Oy), and/or a translation along the axis Oz), and/or a rotation about the axis Ox), and/or a rotation about the axis Oy), and/or a rotation about the axis Oz). If all of these elementary transformations can be performed independently in the position of use, the orthodontic aligner allows “six degrees of freedom”. If two of these elementary transformations are linked, for example due to the fact that a tooth presses against the orthodontic aligner, the orthodontic aligner allows five degrees of freedom. If three of these elementary transformations are linked, the orthodontic aligner allows four degrees of freedom, etc. If a tooth is fully held, it does not have any degree of freedom. If it can move only in one direction, it has only one degree of freedom, even if this direction changes from one point in time to the next. The number of degrees of freedom of the tooth is thus the number of these elementary transformations that the tooth can implement freely.

The “cavity” comprises an occlusal free space which extends between the occlusal inner surface of the tray and the supporting arch, that is to say above the mandible or below the maxillary to which the orthodontic aligner is fixed. It can also comprise, alternatively or in addition to the occlusal free space, preferably in addition to the occlusal free space,
a lingual free space, which extends between the intrados inner surface of the tray and the inner face or “lingual face” of the one or more free teeth that are accommodated in the cavity; and/or
a vestibular free space, which extends between the extrados inner surface of the tray and the outer face or “vestibular face” of the one or more free teeth that are accommodated in the cavity.

A tooth which is accommodated entirely in a cavity, or which, after eruption, will open into a cavity so as to be accommodated entirely therein, is designated a “free tooth”. A tooth is considered to be entirely accommodated in a cavity when its entire surface delimits said cavity.
A region of the orthodontic aligner that defines a cavity is referred to as a “cavity region” 10c. A cavity region is the smallest fraction of the orthodontic aligner which is comprised between two planes perpendicular to the longitudinal axis X of the orthodontic aligner and which completely includes the cavity.

A part of the orthodontic aligner 10 that is not a cavity region is referred to as an “enveloping region” 10e. A tooth at least partially accommodated in an enveloping region is described as an “enveloped tooth”.

The “outer surface” of the orthodontic aligner is the surface opposite the inner surface. It is made up of occlusal outer surfaces 150, intrados and extrados, which extend opposite the occlusal inner surface 130, intrados surface 13i and extrados surface 13e, respectively.

The “bottom” of the orthodontic aligner is made of the material that extends between the occlusal inner and outer surfaces.

A “model” is understood as a digital three-dimensional model. A model is composed of a set of voxels.

A “tooth model” is a three-dimensional digital model of a tooth of a user's dental arch. A model of a dental arch can be segmented so as to define tooth models for at least some of the teeth, preferably for all the teeth represented in the model of the arch. The tooth models are therefore models within the model of the arch.

The terms “comprise”, “include” or “have” should be interpreted broadly and without limitation, unless specified otherwise.

### BRIEF DESCRIPTION OF THE DRAWINGS

Further features and advantages of the invention will become more clearly apparent on reading the following detailed description and on studying the appended drawing, in which:

FIG. 1 shows an example of an orthodontic aligner according to the invention;

FIG. 2 shows an example of a new orthodontic aligner, in the position of use;

FIG. 3 shows an example of a new orthodontic aligner, in the position of use, the user clenching their teeth;

FIG. 4 shows another example of a new orthodontic aligner, in the position of use, the user clenching their teeth;

FIG. 5 shows two photos illustrating the use of a new orthodontic aligner for protecting an auxiliary device;

FIG. 6 shows another photo two photos illustrating the use of a new orthodontic aligner for protecting an auxiliary device;

FIG. 7 illustrates a method according to the invention.

Further details and advantages of the invention are set forth in the following detailed description provided for illustrative and nonlimiting purposes.

### DETAILED DESCRIPTION

### Orthodontic Aligner

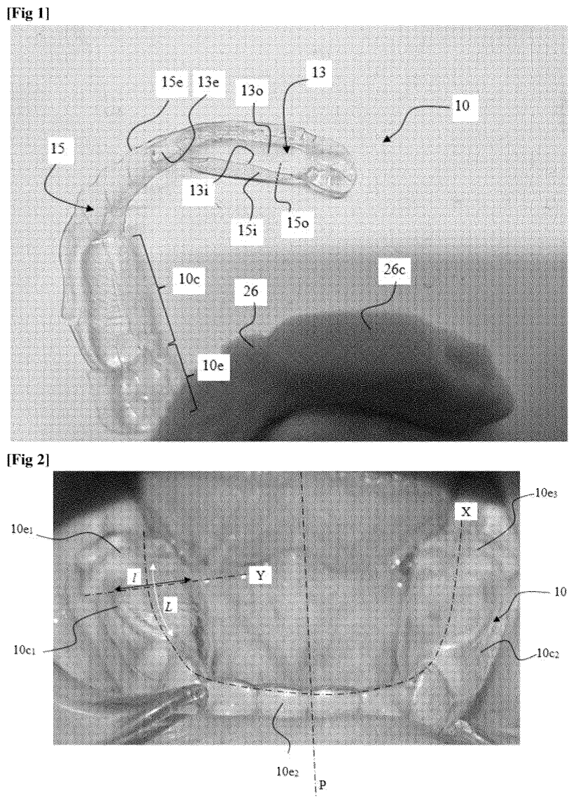

As is shown in FIG. 1, an orthodontic aligner 10, conventionally made of a polymer material, extends in such a way as to follow the successive teeth of the supporting arch that it receives.

According to the invention, it is composed of one or more enveloping regions 10e and one or more cavity regions 10c.

The orthodontic aligner preferably comprises one or two cavity regions, and/or two or three enveloping regions.

In FIG. 2, the orthodontic aligner comprises two cavity regions 10c and three enveloping regions 10e. Preferably, each cavity region is continued, on each side, by an enveloping region. The enveloping regions advantageously stabilize the cavity region that they surround.

The enveloping regions 10e grasp the teeth, that is to say are in close contact with the latter. They can deviate slightly from them, but without ever leaving a space with a volume of more than 5 mm³ between the tray and the supporting arch.

In an enveloping region, the orthodontic aligner closely follows the shape of the teeth, preferably never deviating by more than 1 mm, preferably by more than 0.5 mm, from the surface of the teeth.

In an enveloping region, the orthodontic aligner can exert
a retention stress, that is to say for holding the teeth in position, or
a movement stress for modifying the position of the teeth so as to move them toward a target position, for example in order to correct a malocclusion, or
a fastening stress, determined so as to ensure only the fastening of the orthodontic aligner to the teeth, without any action on the position of the teeth.

Preferably, in an enveloping region, the surface area of the enveloped teeth that is in contact with the orthodontic aligner preferably represents more than 80%, more than 90%, preferably substantially 100% of the surface area of said teeth.

Preferably, the cavity regions are arranged symmetrically with respect to the median plane P of the orthodontic aligner, which is coincident with the sagittal plane in the position of use.

The overall width/of the occlusal outer surface of a cavity region, preferably of each cavity region, is greater than the maximum width of the free tooth or teeth that it accommodates or that are liable to erupt therein. Said width, measured along a horizontal direction Y perpendicular to the curved or C-shaped axis, is preferably greater than 5 mm, preferably greater than 6 mm, and/or less than 10 mm, preferably less than 9 mm, preferably less than 8 mm.

The maximum thickness of the bottom of a cavity region, preferably of each cavity region, is preferably greater than 1 mm and/or less than 5 mm. The minimum thickness of the bottom of a cavity region, preferably of each cavity region, is preferably greater than 0.5 mm and/or less than 2 mm. The difference between said maximum thickness and said minimum thickness is preferably less than 3 mm, preferably less than 2 mm, preferably less than 1 mm. The thickness of the bottom of the orthodontic aligner is preferably substantially constant.

In a preferred embodiment, the thickness of the bottom of the tray in a cavity region is determined in such a way that, in an occlusion position, the outer occlusal surface of said cavity region is not in contact with the teeth of the dental arch antagonist to the supporting arch. In particular, said thickness can be less than the maximum thickness of the bottom of the tray in an enveloping region. The enveloping region thus serves as a stop that limits the movement of the two dental arches toward each other. The cavity defined by the cavity region is then not affected by the masticatory forces.

Alternatively, the orthodontic aligner can be configured in such a way that the masticatory forces are exerted on the cavity region, configured to be deformable under the effect of said masticatory forces. Advantageously, the free teeth subjected to these forces can therefore be brought into orientation accordingly, preferably by being guided by the cavity region.

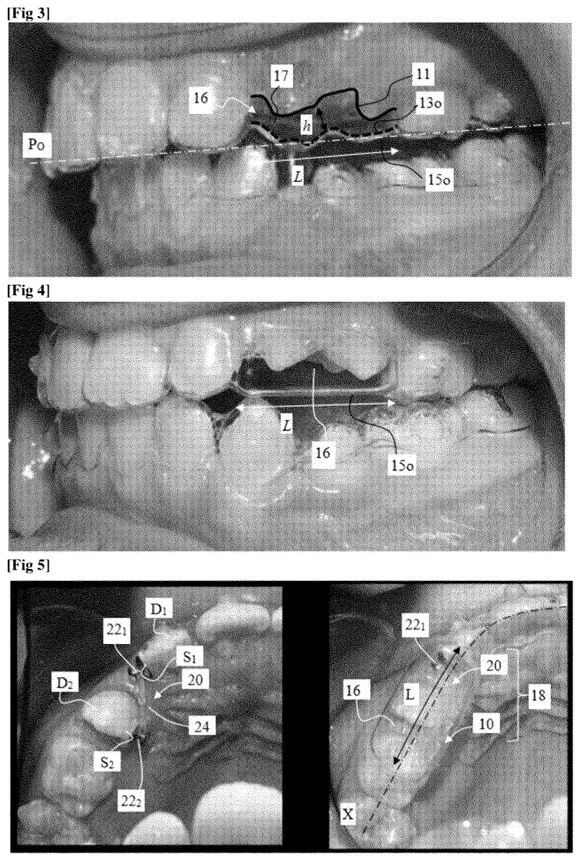

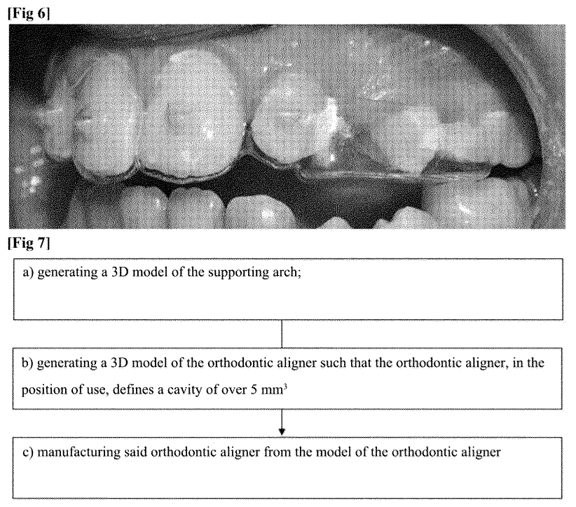

The occlusal outer surface and/or the occlusal inner surface of a cavity region, or even the entire cavity region, may be plane, as is shown in FIG. 2, 4, 5 or 6. Alternatively, it can have a shape similar to the free teeth, in a desired arrangement, as is shown in FIG. 3. The shape of the free teeth can be determined by measurements on the teeth, for example with a scanner or, if the teeth have not yet appeared, from X-ray images. This embodiment is particularly advantageous for guiding the eruption of permanent teeth and for guiding them to a target position.

In one embodiment, in the cavity region, less than 50%, preferably less than 40%, preferably less than 30%, preferably less than 20%, preferably less than 10%, preferably less than 5%, of the occlusal inner surface, and/or of the intrados inner surface, and/or of the extrados inner surface is in contact with the supporting arch.

In a preferred embodiment, in a cavity region, in the position of use, more than 50%, preferably more than 70%, preferably more than 80%, preferably more than 90%, preferably more than 95% of the surface area of the lingual faces and/or of the vestibular faces of the free teeth is in contact with the intrados inner surface and/or the extrados inner surface, respectively, preferably without exerting a movement stress on said teeth, preferably by exerting only fastening stresses.

The cavity region can be used to allow a tooth to move naturally. For example, it makes it possible to protect the natural eruption of a permanent tooth.

The cavity region is preferably configured to also guide the movement of the free tooth, preferably to allow only one or only two degrees of freedom. For example, the cavity region can guide the eruption of a permanent tooth, after loss of the milk tooth, so that it is positioned correctly according to the Lee and Wilson curves.

A cavity region provides a cavity 16 with a volume of greater than 5 mm³ between the tray and the supporting arch. This volume is preferably greater than 10 mm³, preferably greater than 20mm³, preferably greater than 30 mm³, preferably greater than 50 mm³, preferably greater than 80 mm³, preferably greater than 100 mm³, preferably greater than 150 mm³, or even greater than 200 mm³, 250 mm³ or 300 mm³, and/or less than 500 mm³.

In one embodiment, the cavity is closed, that is to say that it does not open to the outside of the orthodontic aligner. Advantageously, the risk of food being introduced into the cavity is thus reduced.

The cavity is preferably configured to allow at least one degree of freedom, preferably at least two, preferably at least three, preferably at least four, preferably at least five, preferably six degrees of freedom, for at least one free tooth.

In other words, in the position of use, the cavity allows at least one free tooth received in the cavity, or capable of being received in the cavity by eruption, to move with at least one, preferably two, preferably three, preferably four, preferably five, preferably six degrees of freedom, without being constrained by the orthodontic aligner.

In one embodiment, the cavity is configured to allow at least one free tooth to rotate on itself, preferably about an axis passing through its center and perpendicular to its occlusal face, preferably over an angular sector of greater than 20°, preferably greater than 30°, preferably greater than 40°, preferably greater than 50°, preferably greater than 60°, and/or less than 180°.

Preferably, however, the cavity is configured to limit the amplitude of the free movement of one or more free teeth, that is to say the orthodontic aligner constitutes a stop which prevents said movement beyond a stop position. In particular, the bottom of the tray can serve as a stop to the eruption of a tooth.

For each point of the surface of the cavity region defining the cavity, it is possible to define the closest point of a free tooth. The distance between these two points measures the local spacing between the orthodontic aligner and the free tooth. Preferably, the greatest of these distances, considering all the points of the surface of the cavity region, or the “maximum spacing”, is greater than 1 mm, preferably greater than 2 mm, preferably greater than 3 mm, preferably greater than 4 mm, preferably greater than 5 mm, preferably greater than 6 mm, and/or less than 10 mm.

Preferably, the cavity, preferably each cavity, has a length L adapted such that, in the position of use, it contains or can contain at least one free tooth, preferably more than 1, preferably more than 2, and/or fewer than 6, preferably fewer than 5, preferably fewer than 4 adjacent teeth. The length of a cavity, preferably of each cavity, measured along the curved or C-shaped longitudinal axis X of the orthodontic aligner, is preferably greater than 5 mm, preferably greater than 10 mm, preferably greater than 15 mm, and/or less than 30 mm, preferably less than 25 mm.

The cavity, preferably each cavity, preferably comprises an occlusal free space 17, and optionally a lingual free space and/or a vestibular free space.

The occlusal free space preferably represents more than 80%, more than 90%, more than 95%, or even 100% of the cavity. It extends between the bottom of the orthodontic aligner and the occlusal face of the free tooth or teeth accommodated in the cavity, or between said bottom and the gum in the absence of a free tooth in the cavity. The maximum height and/or the minimum height of the occlusal free space, measured from said occlusal face, or from the gum in the absence of a free tooth, is preferably greater than 1 mm, preferably greater than 2 mm, and/or less than 6 mm, preferably less than 5 mm, preferably less than 4 mm, preferably less than 3 mm.

The optional lingual free space can have a minimum height and/or a maximum height, measured from the lingual face and perpendicularly with respect to the lingual face, of greater than 0.1 mm, preferably greater than 0.5 mm, and/or less than 2 mm.

The optional vestibular free space can have a minimum height and/or a maximum height, measured from the vestibular face and perpendicularly with respect to the vestibular face of the teeth, of greater than 0.1 mm, preferably greater than 0.5 mm, and/or less than 2 mm.

In a cavity region, preferably in each cavity region, outside the zone defining the cavity, the orthodontic aligner can closely follow the shape of the teeth, for example by never deviating by more than 1 mm or by more than 0.5 mm from the surface of the teeth.

In the cavity region, which defines the cavity, the orthodontic aligner can exert
a retention stress, that is to say a stress for holding the teeth in position, and/or
a movement stress for modifying the position of the teeth, and/or
a slight for ensuring only the fastening of the orthodontic aligner to the teeth, without any appreciable action on the position of the teeth.

Preferably, the orthodontic aligner does not exert any stress on the supporting arch in a cavity region, except optionally a stress for ensuring the fastening of the orthodontic aligner to the teeth, without any appreciable action on the position of the teeth.

### Auxiliary Device

In a particularly advantageous embodiment, the cavity region and the supporting arch together form a cavity that is sufficient to accommodate, in addition to at least one free tooth, preferably at least two free teeth, also an auxiliary device physically connecting said two free teeth to each other or, preferably, a free tooth to an enveloped tooth.

The auxiliary device can in particular be a device with archwire and bracket, or a device with hooks and elastic band. The auxiliary device can in particular comprise first and second hooks fixed to the free tooth and to the enveloped tooth, preferably to the first and second free teeth, respectively, and an elastic band or a chain fixed to the first and second hooks. Such an auxiliary device is particularly effective for rotating a free tooth, at a rate of typically greater than 20°, 30° or even 40° per month. Such a rate should be compared with a rate typically of 4° to 6° per month obtained with conventional orthodontic aligners.

The combination of a new orthodontic aligner and of an auxiliary device, at least partially accommodated in the cavity defined by the cavity region, makes it possible to benefit from the efficiency of the auxiliary device in order to move the free tooth or teeth, while at the same time benefiting from the other teeth being held in position by the orthodontic aligner. The orthodontic aligner also protects the auxiliary device.

In particular, when the cavity region protects an auxiliary device, the cavity can extend in such a way as to be partially defined by an enveloped tooth, as in FIG. 5. For example, the fraction of the surface area of the enveloped tooth that defines the cavity is used in order to fasten a hook thereto. Advantageously, the fraction of this tooth that is in an enveloping region can be held in position and serve as an immobile anchoring point for the auxiliary device.

More specifically, FIG. 5 illustrates an example of an appliance 18 according to the invention comprising an orthodontic aligner 10 according to the invention and an auxiliary device 20. As is illustrated in the image on the left, the auxiliary device comprises first and second hooks 221 and 222 adhesively bonded to first and second surfaces S₁ and S₂ of adjacent first and second teeth D₁ and D₂, and a chain 24 exerting elastic traction between the two hooks. In the image on the right, the orthodontic aligner 10 has been placed in the position of use. The tooth D₁ to be rotated, the gum, and the fraction of the tooth D₂ that bears the second hook delimit a cavity 16 with the orthodontic aligner. The auxiliary device is accommodated entirely in the cavity 16. A fraction of the second tooth D₂ is in an enveloping region, such that the second tooth is held in position and can serve as an anchoring point for the chain. The traction exerted by the chain is thus reflected substantially in full by a rotation of the first tooth D₁.

Preferably, the cavity region defines a substantially closed cavity, which advantageously avoids the user swallowing parts that become detached from the auxiliary device.

### Manufacturing Method

The method according to the invention is illustrated in FIG. 7.

Preferably, the orthodontic aligner is manufactured according to conventional techniques for manufacture of orthodontic aligners, that is to say from an aligner model, itself designed from a model of the supporting arch for which the orthodontic aligner is intended.

It can also be manufactured by thermoforming a polymer sheet on a mold 26 of the modified supporting arch in order to create one or more impressions 26c of cavity regions, as shown in FIG. 1.

An example of a manufacturing method is described below in which the orthodontic aligners are intended for the treatment of a malocclusion.

In step a), a digital three-dimensional model of the supporting arch, referred to as the “initial model”, is generated, for example with a 3D scanner, conventionally at the start of treatment. The initial model represents the teeth in an initial arrangement.

Preferably, the model of the supporting arch is divided into models of the teeth. Techniques for this purpose are well known.

An operator, for example an orthodontist, then manipulates the tooth models using software until a “final model” of the supporting arch is obtained which represents the teeth in a “final” arrangement anticipated for a future final point in time marking the end of the orthodontic treatment. The software for manipulating the tooth models also makes it possible to move the tooth models in order to determine a series of models of the supporting arch with intermediate arrangements of the teeth, such as those anticipated at respective future intermediate points in time, from the initial arrangement to the final arrangement.

In step b), the operator is able to deduce the form of a series of corresponding orthodontic aligners, suitable for modifying the arrangement of the teeth from the initial arrangement to the final arrangement, by way of the intermediate arrangements. Conventionally, the first orthodontic aligner is intended to be worn from the initial point in time to the first intermediate point in time, the second orthodontic aligner is intended to be worn from the first intermediate point in time to the second intermediate point in time, etc., and the last orthodontic aligner is intended to be worn from the last intermediate point in time to the final point in time.

In step c), the models of the orthodontic aligners are transmitted to a manufacturing machine, for example a 3D printer, in order to manufacture said orthodontic aligners.

The manufactured orthodontic aligners are then supplied to the user, who wears them in succession.

The steps described above are conventional in the manufacture of orthodontic aligners. In particular, the software for dividing the initial model of the supporting arch into tooth models, then for deforming it, by movement of the tooth models, so as to generate the intermediate models and the final model, is well known.

According to the invention, the models of the orthodontic aligners are deformed so that the orthodontic aligners can create a cavity in the position of use. Such a deformation does not present any particular difficulty and may be carried out using any model modification software, such as Memotech (Smilers). In particular, it is possible to numerically simulate the position of use by arranging the model of an orthodontic aligner, for example designed in a conventional manner, on the model of the supporting arch, then to move points of the model of the orthodontic aligner in order to create a cavity.

It is also possible to determine the dimensional characteristics of the cavity, for example the volume of the cavity or the maximum spacing from a free tooth. The aligner model can be easily modified in order to modify these dimensional characteristics.

In one embodiment, no modification of the arrangement of the teeth of the supporting arch other than the free teeth is desired outside the region of the free tooth or teeth.

In one embodiment, no modification of the arrangement of the teeth of the supporting arch is desired, for example when the orthodontic aligner is used only to protect a tooth during eruption. It is then possible to design a model of an orthodontic aligner having substantially the shape of the model of the supporting arch, then to deform it locally in order to create the cavity.

As is now clearly apparent, a new orthodontic aligner makes it possible, in the position of use, to define a cavity in order to
allow the movement of one or more teeth and/or of an auxiliary device, the walls defining the cavity being able to optionally guide and/or limit the amplitude of this movement;
simultaneously use an auxiliary device and enveloping regions, which may be similar to conventional orthodontic aligners, notably for anchoring to the teeth or for modifying the position of the teeth.

The new orthodontic aligner also makes it possible to protect the auxiliary device from impacts and to avoid pieces of this device being swallowed.

Finally, the cavity region can be used to keep apart teeth arranged, at least partially, in adjacent enveloping regions, for example in order to facilitate the eruption of teeth.

Of course, the invention is not limited to the embodiments described above and shown.

In particular, in one embodiment, the orthodontic aligner is manufactured by thermoforming by means of a physical model of the user's dental arch, for example a plaster model or resin model, modified so that the orthodontic aligner has at least one cavity region. Steps a) to c) are then replaced by the following steps:
a′) generating a physical model of the supporting arch;
b′) modifying the physical model by at least one addition of material suitable for creating a cavity region in the orthodontic aligner manufactured in the following step, step c′);
c′) manufacturing the orthodontic aligner by thermoforming on the modified physical model obtained in step b′).

All of the features described above are applicable to this embodiment, except where technically incompatible. Thermoforming is a well-known technique in the field of orthodontics.

An orthodontic treatment may be therapeutic and/or esthetic.

1. A method for manufacturing at least one orthodontic aligner intended to be carried, in a position of use, by a user's dental arch, referred to as a “supporting arch”, the supporting arch comprising a first tooth and a second tooth and carrying or being intended to carry an auxiliary device comprising a member connecting a first surface of the first tooth to a second surface of the second tooth, the method comprising the following steps:
a) generating a digital three-dimensional model of the supporting arch;
b) from the digital three-dimensional model of the supporting arch, generating a digital three-dimensional model of the orthodontic aligner configured such that
said orthodontic aligner can be fixed, in a removable manner, to the supporting arch, in a position of use,
said orthodontic aligner, in the position of use, defines, with the supporting arch, a cavity configured to accommodate the auxiliary device, said first and second surfaces belonging to the surface of the supporting arch defining, with said orthodontic aligner, said cavity, only the first tooth, from the first and second teeth, being accommodated entirely in the cavity, and
c) manufacturing said orthodontic aligner from the model of the orthodontic aligner; the region of said orthodontic aligner defining said cavity being referred to as the “cavity region”.

2. The method as claimed in claim 1, wherein:
in step a), a digital three-dimensional model of the auxiliary device is generated;
in step b), the model of the auxiliary device is positioned on the model of the supporting arch, and then the digital three-dimensional model of the orthodontic aligner is generated using the model of the supporting arch on which the model of the auxiliary device was positioned.

3. The method as claimed in claim 1, wherein the digital three-dimensional model of the orthodontic aligner is configured such that, in the position of use, the second tooth is held in position by the orthodontic aligner.

4. The method as claimed in claim 1, wherein the digital three-dimensional model of the orthodontic aligner is configured such that, in the position of use, the orthodontic aligner is not in contact with the first tooth and is in contact with more than 10% of the surface of the second tooth.

5. The method as claimed in claim 1, wherein the cavity allows the first tooth to rotate on itself, about an axis that passes through its center and is perpendicular to its occlusal face, over an angular sector of greater than 20°.

6. The method as claimed in claim 1, wherein the cavity has a length, measured along the longitudinal axis of the orthodontic aligner, of greater than 10 mm.

7. The method as claimed in claim 1, wherein
the auxiliary device comprises first and second hooks which are intended to be rigidly fixed to the first and second surfaces and to which the member is fixed, or wherein
the member is a wire adhesively bonded to the first and second surfaces,
the member being designed so as to exert a tension between said first and second hooks.

8. The method as claimed in claim 1, wherein said orthodontic aligner is shaped such that said cavity has a volume greater than 80 mm³.

9. The method as claimed in claim 1, wherein the digital three-dimensional model of the orthodontic aligner is shaped such that, in the position of use, the orthodontic aligner modifies the position and/or the orientation of at least a third tooth other than the first and second teeth.

10. The method as claimed in claim 1, wherein the cavity comprises an occlusal free space extending between the occlusal inner surface of the orthodontic aligner and the occlusal surface of the supporting arch, the auxiliary device being accommodated in the occlusal free space.

11. The method as claimed in claim 1, wherein the orthodontic aligner is configured in such a way that, in the position of use and in an occlusion position, the outer occlusal surface of the cavity region
is not in contact with the teeth of the dental arch antagonist to the supporting arch, or
is in contact with the teeth of the dental arch antagonist to the supporting arch and is deformable under the effect of the masticatory forces.

12. The method as claimed in claim 1, wherein the orthodontic aligner is configured in such a way as to guide the eruption of at least one tooth, the orthodontic aligner having, in said cavity region, a plane occlusal inner surface or having a shape such that, in a predefined position of said tooth, no point of said tooth is spaced apart by more than 1 mm from said occlusal inner surface.

13. The method as claimed in claim 1, wherein the cavity is closed, and/or wherein the cavity region has a plane occlusal outer surface.

14. The method as claimed in claim 1, implemented to manufacture a plurality of orthodontic aligners intended to be worn successively in the context of orthodontic treatment of a malocclusion.
